(19) United States
(12) Patent Application Publication
(10) Pub. No.: US 2008/0264350 A1
(43) Pub. Date: Oct. 30, 2008

(54) Protective device for an animal

(76) Inventor: James D. Frevola, Northport, NY (US)

Correspondence Address: Paul J. Esatto, Jr.;Scully, Scott, Murphy & Presser, P.C., Suite 300, 400 Garden City Plaza, Garden City, NY, 11530, US

(21) Appl. No.: 11/796,473

(22) Filed: Apr. 27, 2007

(51) Int. Cl. A01K 25/00

(52) U.S. Cl. 119/831

(57) ABSTRACT

A protective device for an animal includes a substantially rigid mandible mask substantially housing the mandible and the mouth of an animal, but not the top of the snout of the animal. The mask defines at least one opening in a bottom portion of the mask positioned to allow debris to egress. An at least semi rigid front restraining member is coupled to opposite sides of the mandible mask and adapted to extend over the snout of the animal. A rear restraining member is coupled to opposite sides of the mandible mask and adapted to extend around the neck of the animal. The rear restraining member and the front restraining remember are adapted to fit such that the device is substantially fitted to the animal's head whereby the animal cannot contact its mouth with an afflicted area of its body.

### FIELD OF THE INVENTION

The present invention relates to a device for preventing an animal from using its mouth on an afflicted area of the animal's body during the course of a veterinary treatment, and more specifically, to a protective device fitted about an animal's head for preventing an animal from biting or licking post surgery stitches or wounds or other areas of treatment during the course of veterinary treatment.

### BACKGROUND OF THE INVENTION

During the course of veterinary treatment of an animal, it may become necessary to restrict the animal ability to use its mouth on an afflicted area of the animal's body. For instance, animals are known to bite, lick, or nibble at afflicted areas of their bodies, such as, wounds, sores, rashes, sutures, hot spots, flea bites, and also chew at bandages or pull out intravenous catheters and the like. This interferes with the healing process after surgery or other veterinary treatment. Various devices have been designed to discourage an animal's ability to access its afflicted area, e.g., stitches, wounds and the like in order to allow unfettered healing after surgery or otherwise.

Elizabethan-type collars are typically employed to discourage an animal's mouth from reaching an afflicted area on the animal's body. These are typically of conical, toroidal, or tubular configuration, fitting around the animal's neck, and sometimes having radially-extending projections to further hamper the animal's freedom of movement. Further known are devices that encapsulate the animal's head, and devices that snugly fit the animal's neck and are configured in length and material to prevent meaningful movement. Other devices purport to permit more freedom of movement for the animal's head by covering the affected area in the form of a vest or jacket. Muzzles are also known, and are used to prevent the animal from biting by preventing opening of the mouth by encapsulating or completely surrounding the snout, i.e., the mandible and nose of the animal.

However, known devices have disadvantages while preventing the animal from using its mouth. For example, known devices using Elizabethan-type collars are cumbersome to use and manifestly interfere with animal's ability to eat, drink and sleep. Additionally, the collars themselves are cumbersome for the animal, for the owner to handle the animal, and can damage potential points of contact, such as, walls, furniture, and other items. Other devices such as the vest or jacket are uncomfortable for the animal to wear and are hard for the owner or veterinarian to affix to the animal. Muzzles are unsuited for longer term application to allow healing of an afflicted area or even an overnight veterinary application. Muzzles surround the entire snout of the animal, and therefore prevent the animal from opening its mouth, which could lead to aspiration and the like should emesis occur, as well as, preventing the animal from eating or drinking, and substantially interfering with breathing freely.

Therefore, a need exists for a protective device that allows an animal greater freedom of movement, is not cumbersome, is easy to apply, allows the animal to open its mouth to take in food and water, and yet still precludes the animal from achieving contact of its mouth to an afflicted area of its body.

### SUMMARY OF THE INVENTION

In an aspect of the invention, a protective device for an animal includes a substantially rigid mandible mask substantially housing the mandible and the mouth of an animal, but not the top of the snout of the animal. The mandible mask substantially prevents the animal from contacting its mouth with an afflicted area of its body, and the mask defines at least one opening in a bottom portion of the mask positioned to allow debris to egress. An at least semi rigid adjustable front restraining member coupled to opposite sides of the mandible mask and fitting over a distal end of the head of the animal to adjustably encompass the distal end of the head using the front restraining member and the mandible mask. A rear restraining member is coupled to opposite sides of the mandible mask and fitting around the neck of the animal in an adjustable closed loop.

In a related aspect, the at least semi rigid front restraining member is adjustably coupled to the opposite sides of the mandible mask and fitted over the distal end of the head of the animal. The mandible mask adjustably encompass the distal end of the head using the front restraining member and the mandible mask.

In a related aspect, the rear restraining member extends around the neck and behind the ears of the animal.

In a related aspect, the front restraining member extends over a snout of the animal.

In a related aspect, the at least one opening includes a plurality of openings and a front opening at a distal end of the mask.

In a related aspect, the mask includes a front portion for housing the mouth of the animal while allowing the animal to open and close its mouth.

In a related aspect, the housing allows the animal to drink by opening its mouth or using its tongue within the perimeter of the mask.

In a related aspect, the mask substantially prevents the animal from contacting its tongue with the afflicted area of its body.

In a related aspect, the mandible mask houses the lower jaw of the animal and an integral front portion of the mask houses the mouth of the animal substantially preventing the animal from contacting its mouth and tongue with the afflicted area of its body.

In a related aspect, the sides of the mask cover at least a portion of the cheeks or jowls of the animal.

In a related aspect, the rear restraining member is a flexible strap.

In a related aspect, the rear restraining member comprises straps that adjustably connect around the neck of the animal.

In a related aspect, the front restraining member is removably coupled.

In a related aspect, the front and rear restraining members are fixedly adjustable.

In a related aspect, the front and rear restraining members are comprised of rigid or semi-rigid materials.

In a related aspect, the front restraining member includes a compressible material in contact with a snout of the animal.

In a related aspect, the rear restraining member is also adjustably secured to a coupling element about midway between the opposite sides of the mandible mask.

In a related aspect, the mandible mask is made of plastic.

In a related aspect, the plastic comprises a polyolefin, a polyester, a polycarbonate, or a polyurethane, and the polyolefin comprises polyethylene or polypropylene.

In another aspect of the invention, a protective device for an animal comprises a substantially rigid mask having a mandible housing portion substantially housing the mandible and a mouth housing portion substantially housing the mouth of an animal, but not the top of the snout of the animal. The mandible mask substantially preventing the animal from contacting its mouth with an afflicted area of its body. The mask defines a plurality of openings in a bottom portion of the mask and a front opening at a distal end of the mask both positioned to allow debris to egress. An at least semi rigid fixedly adjustable front restraining member coupled to opposite sides of the mask and fitting over the snout of the animal to adjustably encompass the distal end of the head using the front restraining member and the mandible mask. A fixedly adjustable rear restraining member coupled to opposite sides of the mask and fitting around the neck and behind the ears of the animal in an adjustable closed loop.

In another aspect of the invention, a method of protecting an animal comprises housing the mandible and the mouth of an animal using a substantially rigid mandible mask, but not the top of the snout of the animal; providing at least one opening in a bottom portion of the mask positioned to allow debris to egress; and fitting the device to the animal's head such that the animal cannot contact its mouth with an afflicted area of its body.

In a related aspect, the method further includes securing over a distal end of the head of the animal an at least semi-rigid front restraining member, and securing around the neck of the head of the animal a rear restraining member such that both the front and rear restraining members are coupled to opposite sides of the mandible mask.

In a related aspect, the method further includes securing the front restraining member over the snout of the animal.

In a related aspect, the method further includes adjusting the front and rear restraining members to fit the device to the animal's head.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a side perspective view of a protective device according to an embodiment of the invention fitted on a dog;

FIG. 2 is a perspective view of the protective device shown in FIG. 1 depicting the bottom and side areas of the device and the loops and strap for securing the device to an animal's head;

FIG. 3 is a side perspective view of the protective device shown in FIGS. 1 and 2 depicting the loops without the strap shown in FIG. 2; and

FIG. 4 is a bottom perspective view of the protective device shown in FIGS. 1-3.

### DETAILED DESCRIPTION OF THE INVENTION

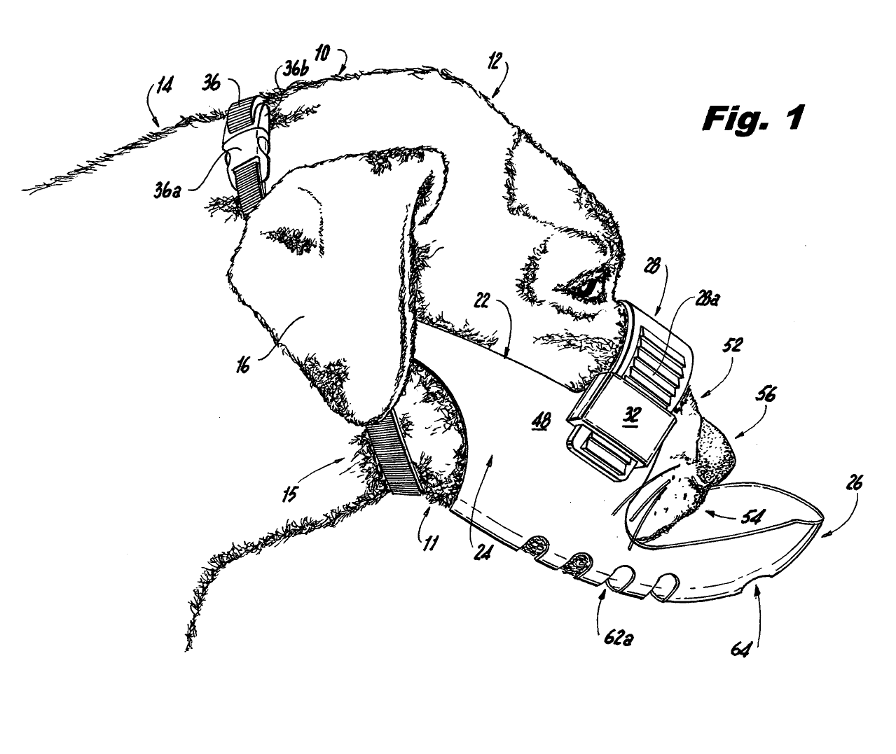

An exemplary embodiment of a protective device 20 according to the present invention for an animal 10 is shown in FIGS. 1-4. The animal 10 shown for illustrative purposes is a dog, however, the device 20 may be used with other animals, for example, cats, or horses, or other animals having a snout, or an animal having a less pronounced snout or nose and jaw area. Generally, the protective device embodied as a canine facemask 20 for the animal 10 includes a mask 22 including a lower jaw mask portion 24 integral with a mouth and nose mask portion 26 formed to cover substantially the length and sides of the mandible (lower jaw) 11 of the animal 10. The lower jaw mask portion 24 of the mask 22 extends upwardly to cover all or a portion of the animal's cheeks or jowls to further hamper the ability to bite affected areas.

An at least semi rigid front restraining member embodied as a snout restraining strap 28 is adjustably coupled to front strap housings 32 connected to side portions 48 integral with the lower mask portion 24. The snout-restraining strap 28 extends over the animal snout 52 and across the top of the mask 22. The restraining strap 28 includes ridges 28a at opposing ends (only one end is shown for illustrative purposes in FIGS. 1-3), which removably and adjustably couple to mating tongs (not shown) in the front strap housing 32 to allow ratchet-like tightening of the strap 28 around the animal's snout 52. Thus, the snout restraining strap 28 can be fitted snugly about the animal's snout as shown in FIG. 1, by ratcheting the ridges 28a of the strap 28 through the mating housings 32. The snout restraining strap 28 may also be tightened using, for example, fastening straps. In an alternative embodiment, the snout restraining strap 28 may be permanently affixed to the mask using rivets or the like and slid over the snout of the animal with or without adjustment. In another alternative embodiment, the snout restraining strap may be integral with the mask and thereby is fitted to the snout of the animal by sliding the strap over the snout without adjustment. The snout restraining strap 28 is semi rigid, and thus can flex somewhat over the animal's snout without being susceptible to extensive flexing or bending by the animal. For example, the animal cannot use a paw to twist or distort the snout restraining strap 28 to push the restraining strap 28 over it's nose, thereby removing the device 20. The front restraining member or snout restraining strap may include a compressible material such as foam or a foam-like substance as a covering for comfort to the animal. The front restraining member in alternative embodiments, for example, may include for fastening the member to the mask, hook and loop fasteners (e.g., VELCRO®), belt-like fasteners, or a magnetic fastener.

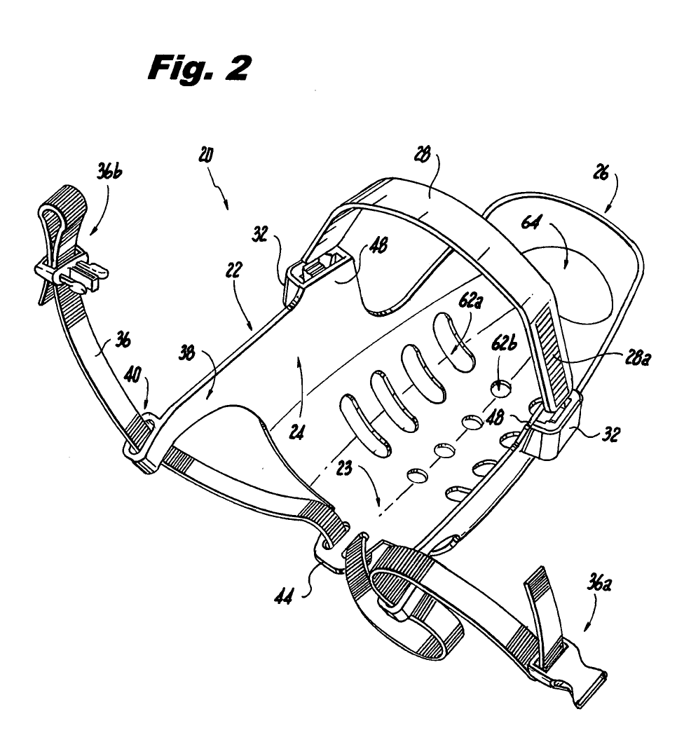

A rear restraining member embodied as a head restraining strap 36 (shown in FIGS. 1 and 2) is removable and adjustably coupled to rear strap housings 40 and strap loop member 44 having openings 45 (shown in FIG. 4) to fit over the back of the animal's 10 head 12. The adjustable head restraining strap 36 shown in FIG. 1, includes a receiving housing 36a and an insert portion 36b which removably snap together to provide a snug fit around the back of the animal's 10 head 12. The rear strap housings 40 are integrally formed on rearwardly extending portions 38 of the mask 22, as shown in FIG. 2. The head restraining strap 36 extends behind the head 12 and ears 16 of the animal 10, and under the lower jaw 11 towards the neck 15 of the animal 10, encircling the neck. The head restraining strap 36 is configured to be in contact with and provide a snug fit to the animal's 10 head 12, and may include, for example, padding where it contacts the animal's head. The head restraining strap 36 may be flexible or more rigid, provided it fits comfortably and snugly around the animal's 10 head/neck area without choking the animal. The head restraining strap 36 may be made of, for example, nylon, leather, cotton or rubber. An alternative head restraining member may include, for example, a strap with snaps, clips, or hook and loop fasteners, or an elastic collar or a collar having elastomeric properties or materials.

In the embodiment of the device 20 and mask 22 depicted in FIGS. 1-4, the mask 22 approximates a hemispherical cross section, to fit about the animal's lower mandible. Although a hemispherical-like configuration provides a mask 22 shaped to adequately cover the sides of the animal's mandible, it is understood that the mask 22 is not so limited and other cross sections (e.g. truncated polygons such as trapezoids, squares, rectangles and the like) may be used provided that the mask covers the mandible. The mask 22 does not cover the top of the animal's snout 52 (i.e., the projecting part of the animal's head, consisting of the nose and mouth) thereby permitting the animal to partially open and close its mouth 54 and does not interfere with the animal's nose 56 thereby allowing the animal to breathe freely. The mask 22 covers substantially the length of the animal's mandible 11 and it's mouth 54. The animal can open its mouth enough to take in food when hand fed, water and medicine, however, when wearing the device of the present invention, the animal is effectively precluded from engaging its lower jaw when it turns its head to bite, nibble and lick affected areas on its own body. In another embodiment of the protective device, a front restraining member may, for example, extend over the part of the animal's head between the eyes and ears. This placement of the front restraining member allows the device to be used, for example, on animals having a small snout. The protective device may vary in size to be customized to specific animals or specific breeds of animals.

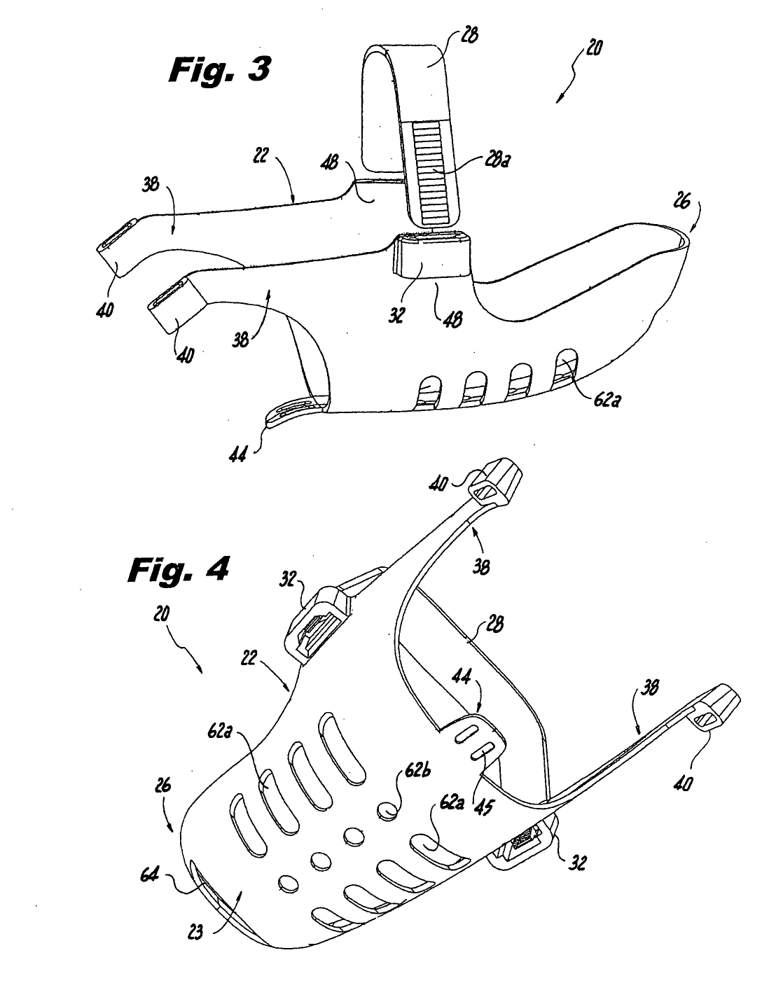

Further, referring to FIGS. 1-3, the illustrative embodiment of the protective device 20 (shown in FIG. 2) includes the mask 22 comprising the lower jaw mask portion 24 of the mask 22 and the mouth and nose mask portion 26 made of a semi-rigid or rigid material (as shown in FIGS. 2 and 3). The mask 22 houses the mandible of the animal while not unduly restricting the lower jaw and snout of the animal. Thus, the device 20 is comfortable for the animal. Examples of materials suitable for the mask 22 of the device include those that are suitably lightweight so as not to be an undue impediment for the animal, and yet be sufficiently rigid to not overly flex or bend.

Thereby, the material of the lower jaw mask portion 24 substantially hampers the animal from contacting its mouth to an afflicted area, such contact including biting, nibbling or licking the afflicted area when, for example, the animal turns it head to do so. Thus, during the course of veterinary treatment of the animal, the device 20 restricts the animals ability to use its mouth or tongue on an afflicted area of the animal's body, that includes, for example, wounds, sores, rashes, sutures, hot spots, flea bites, and also chewing at bandages or pulling out intravenous catheters and the like. An example of materials meeting this criteria is plastics, and further, suitable plastics include thermoplastics, such as polyolefins (e.g. low density polyethylene, high density polyethylene, polypropylene and the like), polycarbonates, polyesters, polyurethane, and the like, and those formed from liquid polymerization using stereolithographic (SLA) techniques. The thickness needed for the protective device 20 is dependent on the chosen material of construction. As appreciated by those in the art, such materials can be molded (e.g. injection molded), formed from a sheet, or solvent welded from component pieces etc. to form the device of the invention.

Also, as shown in FIGS. I and 2, the device 20 has upwardly extending side portions 48 integral with the lower jaw mask portion 24. The bottom area 23 (best shown in FIGS. 2 and 4) of the mask 22 includes a plurality of drainage openings 62a, 62b, some of which openings 62a are elongated and extend up the side of the lower jaw mask portion 24 and other 62b which are circular and are along the bottom of the mask 22. The drainage openings 62a, 62b allow egress of drool, or water that may remain from drinking, or other liquids and debris that may otherwise collect, as well as, allowing air passages for the animal's comfort. As shown more prominently in FIG. 2, the mask 22 has a frontal opening 64 which is proximate the animal's nose to facilitate breathing. The opening 64 can be sized to permit the animal some restricted ability to lick in order to take up water, as e.g. may be provided by bottle or the like, while preventing the animal from substantial contact with an afflicted area.

In operation, the protective device 20 is fitted over the animal's 10 snout 52 thereby housing the mandible 11 and the mouth 54 of the animal 10 with the lower mask portion 24 of the mask 22, but not the top of the snout 52 of the animal 10. The front restraining member 28 is fitted over the snout 52 of the animal 10. The rear restraining member 36 is fitted over the neck 14 and behind the ears 16 of the animal 10. The mask 22 securely houses the animal's mandible and mouth by tightening the front restraining member of the animal's snout and the rear restraining member around the neck 15 and directly behind the head 12 of the animal. As the front and rear restraining members 28, 36 are tightened, the front strap housings 32 and the rear strap housings 40 are pulled inwardly along with the semi-flexible mask 22. The upwardly extending side portions 48 flex inwardly to snugly fit around the animals snout 52. Thus, the mask 22 houses the animal's mandible and mouth area, and snugly fits about the snout 52 and neck 15 of the animal, such that the animal cannot contact its mouth with an afflicted area of its body. The animal does have enough lower jaw mobility to take pieces of food when hand fed and water using its tongue. Debris from the food or water, or any emesis is evacuated through the plurality of openings 62a, 62b, 64.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A protective device for an animal comprising:
a substantially rigid mandible mask substantially housing the mandible and the mouth of an animal, but not the top of the snout of the animal, the mandible mask substantially preventing the animal from contacting its mouth with an afflicted area of its body, and the mask defines at least one opening in a bottom portion of the mask positioned to allow debris to egress;
an at least semi rigid front restraining member coupled to opposite sides of the mandible mask and fitting over a distal end of the head of the animal to encompass the distal end of the head using the front restraining member and the mandible mask; and
a rear restraining member coupled to opposite sides of the mandible mask and fitting around the neck of the animal in an adjustable closed loop.

2. The device of claim 1, wherein the at least semi rigid front restraining member is adjustably coupled to the opposite sides of the mandible mask and fitted over the distal end of the head of the animal to adjustably encompass the distal end of the head using the front restraining member and the mandible mask.

3. The device of claim 1, wherein the rear restraining member extends around the neck and behind the ears of the animal.

4. The device of claim 1, wherein the front restraining member extends over a snout of the animal.

5. The device of claim 1, wherein the at least one opening includes a plurality of openings and a front opening at a distal end of the mask.

6. The device of claim 1, wherein the mask includes a front portion for housing the mouth of the animal while allowing the animal to open its mouth.

7. The device of claim 1, wherein the mask allows the animal to drink by opening its mouth or using its tongue within the perimeter of the mask.

8. The device of claim 1, wherein the mask substantially prevents the animal from contacting its tongue with the afflicted area of its body.

9. The device of claim 1, wherein the mandible mask houses the lower jaw of the animal and an integral front portion of the mask houses the mouth of the animal substantially preventing the animal from contacting its mouth and tongue with the afflicted area of its body.

10. The device of claim 1, wherein the sides of the mask cover at least a portion of the cheeks of the animal.

11. The device of claim 1, wherein the rear restraining member is a flexible strap.

12. The device of claim 1, wherein the rear restraining member comprises straps that adjustably connect around the neck of the animal.

13. The device of claim 1, wherein the front restraining member is removably coupled.

14. The device of claim 1, wherein the front and rear restraining members are fixedly adjustable.

15. The device of claim 1, wherein the front and rear restraining members are comprised of rigid or semi-rigid materials.

16. The device of claim 1, wherein the front restraining member includes a compressible material in contact with a snout of the animal.

17. The device of claim 1, wherein the rear restraining member is also adjustably secured to a coupling element about midway between the opposite sides of the mandible mask.

18. The device of claim 1, wherein the mandible mask is made of plastic.

19. The device of claim 18, wherein the plastic comprises a polyolefin, a polyester, a polycarbonate, or a polyurethane.

20. The device of claim 19, wherein the polyolefin comprises polyethylene or polypropylene.

21. A protective device for an animal comprising:
a substantially rigid mask having a mandible housing portion substantially housing the mandible and a mouth housing portion substantially housing the mouth of an animal, but not the top of the snout of the animal, the mandible mask substantially preventing the animal from contacting its mouth with an afflicted area of its body, and the mask defines a plurality of openings in a bottom portion of the mask and a front opening at a distal end of the mask both positioned to allow debris to egress;
an at least semi rigid fixedly adjustable front restraining member coupled to opposite sides of the mask and fitting over the snout of the animal to adjustably encompass the distal end of the head using the front restraining member and the mandible mask; and
a fixedly adjustable rear restraining member coupled to opposite sides of the mask and fitting around the neck and behind the ears of the animal in an adjustable closed loop.

22. A method of protecting an animal comprising:
housing the mandible and the mouth of an animal using a substantially rigid mandible mask, but not the top of the snout of the animal;
providing at least one opening in a bottom portion of the mask positioned to allow debris to egress; and
fitting the device to the animal's head such that the animal cannot contact its mouth with an afflicted area of its body.

23. The method of claim 22, further including securing over a distal end of the head of the animal an at least semi-rigid front restraining member, and securing around the neck of the head of the animal a rear restraining member such that both the front and rear restraining members are coupled to opposite sides of the mandible mask.

24. The method of claim 22, further including securing the front restraining member over the snout of the animal.

25. The method of claim 22, further including adjusting the front and rear restraining members to fit the device to the animal's head.
